(19) United States
(12) Patent Application Publication
(10) Pub. No.: US 2022/0237500 A1
(43) Pub. Date: Jul. 28, 2022

(54) TEST CASE EXECUTION SEQUENCES

(71) Applicant: Dell Products L.P., Round Rock, TX (US)

(72) Inventors: Hung Dinh, Austin, TX (US); Bijan Mohanty, Austin, TX (US); Vasanth Sathyanarayanan, Bangalore (IN); Akanksha Goel, Faridabad (IN); Parminder Singh Sethi, Ludhiana (IN)

(73) Assignee: Dell Products L.P., Round Rock, TX (US)

(21) Appl. No.: 17/155,533

(22) Filed: Jan. 22, 2021

(51) Int. Cl. G06N 20/00; G06F 11/263; G06F 16/23

(52) U.S. Cl. CPC G06N 20/00; G06F 16/2379; G06F 11/263

(57) ABSTRACT

A system and method reorder execution of a test suite to be performed on a given device according to an initial testing order. Each testing sequence in the test suite is analyzed for dependencies between test cases, and these dependencies are recorded in directed graphs. Next, a machine learning algorithm, such as the random forest algorithm, is trained on multi-dimensional historical testing data according to several testing parameters to predict success or failure of any given test. The trained algorithm is used to predict, for a given device under test, which of the test cases are likely to fail, and to compute a confidence value for each such prediction. The directed graphs then are reorganized so that graphs containing tests most likely to fail are executed early in the test suite, according to a modified testing order that accounts for both test dependencies and the confidence values.

### FIELD

The disclosure pertains generally to detecting or locating defective hardware or software using an automated test suite, and more particularly to managing the order of tests in the test suite according to previous experience with similar hardware or software.

### BACKGROUND

Millions of consumer and enterprise devices such as computers, smartphones, televisions, and computer networking appliances are manufactured every year. During the manufacturing process, automation tests are run for each device to validate the quality of a device before it is shipped. The number of automated test cases that are run may vary based on the device type. In case of laptops, for example, it is common for at least 20,000 to 30,0000 test cases to be run, with a single test cycle taking upwards of 24 hours. In general, the number of test cases needed to be run can increase significantly even beyond this, based on the complexity of the device.

Consider a scenario in which the 18,000^{th} test case, in a test suite of 20,000 tests, failed during the first cycle of automation testing. If this failure is common in the device under test, the failure will occur at the same, late position in the test suite in subsequent test cycles for the same or similar product. Thus, the testing process make take longer than necessary, resulting in inefficient testing and a delay in certifying the device ready for end use.

Determining a more efficient order of testing, however, may be quite difficult due to the nature of how test suites are constructed. In particular, some tests are independent of others and may be executed in any order, while dependent tests use the output of other tests as their input(s). Thus, dependent test cases must run in a specific sequence, i.e. after the tests whose outputs they use. Moreover, the depended-upon tests may themselves be either independent or dependent, and complex inter-relationships can occur between the tests that prevent a simple re-ordering within the test suite. Therefore, existing automation processes often execute tests according to a static order assigned prior to testing.

To illustrate this problem, consider FIG. 1, which shows a hypothetical test suite where test cases 11, 12, 13, 14, 15, 16, and 17 relate to a common device (or particular feature) under test and are executed in the indicated order. As shown in FIG. 1, the outcome of test case 12 is used as an input for test case 13, and the outcome of test case 13 is used as an input for test cases 14 and 16. If test case 12 fails, then it is likely that test case 13 will fail because it has received bad (or no) input, and it is further likely that test cases 14 and 16 will fail for the same reason. However, because the order in which these test cases is pre-determined, test cases 14 and 15 will execute before test case 16 executes, delaying report of the latter's likely failure to the tester and thereby slowing the testing process.

### SUMMARY OF DISCLOSED EMBODIMENTS

Disclosed embodiments reorder execution of test suites so that their test cases (or simply “tests”) most likely to fail are performed before those most likely to succeed. Embodiments estimate the likelihood that any given test will succeed or fail by applying machine learning techniques to historical testing data. The random forest classification model is most effective in this connection, although other models might be used. Test dependencies are represented as directed graphs, and the testing sequence is reordered so that tests are executed following the edges of each graph where the test most likely to fail executes as early as possible. Separating the tests into dependency graphs moreover allows testing to be performed in parallel, if desired, further accelerating the testing process.

Thus, a first embodiment is a system for reordering execution of a test suite that is stored in a test suite database and that comprises a plurality of tests to be performed on a given device according to an initial order. The system has a graph processor for creating a plurality of directed graphs comprising nodes and edges. Each node represents a test in the plurality of tests and each edge from a first node to a second node represents creation of an output, by the first node, that is used as an input by the second node. The system also has a training database for storing parametric training data obtained from performance of the test suite on devices other than the given device. The system further has a prediction processor for using a machine learning algorithm, trained using data stored in the training database. The prediction processor is used to predict, for each test in the plurality of tests, whether performance of that test on the given device is likelier to succeed or fail according to parametric data for the given device. The prediction processor is also used to generate a confidence value for each such prediction. The system finally includes a reordering processor for creating, for performance on the given device, a test suite comprising the plurality of tests rearranged according to a modified order. At least one test, predicted to fail by the prediction processor, appears earlier in the modified order than in the initial order.

In some embodiments, the training data comprise a plurality of records, each record relating to a test and including data indicating both success or failure of the test, and one or more of: a unique device identifier, a device operating system identifier, a device testing application version, a device model identifier, a test identifier, a test cycle number, a dependency tree identifier, and a dependency tree level identifier.

In some embodiments, the prediction processor is configured to use a random forest machine learning algorithm. The random forest algorithm predicts performance of at least one test in the plurality of tests by aggregating predictions of a plurality of decision trees in a random forest. The random forest algorithm also generates the confidence value as a ratio of (a) the number of decision trees within the plurality of decision trees whose predictions agree with the predicted performance, to (b) the number of trees in the plurality of trees.

In some embodiments, the reordering processor creates the test suite according to the modified order by (a) determining a set of directed paths, in the plurality of directed graphs, that each end on a node that represents a test that was predicted likelier to fail than successful; then (b) ordering the set of directed graphs by increasing length of the shortest directed path therein; and then (c) further ordering the set of directed graphs by decreasing maximum confidence value.

In some embodiments, determining the set of directed paths includes, for each test that was predicted likelier to fail than successful, identifying the edges in a corresponding directed path for that test by traversing the directed graph that comprises the test from the node representing that test to a root node.

Some embodiments further include a plurality of testing processors, each testing processor in the plurality configured to perform, on the given device, the tests represented by nodes in a directed path according to the modified order.

Another embodiment is a method of reordering execution of a test suite that is stored in a test suite database and that comprises a plurality of tests to be performed on a given device according to an initial order. The method begins with creating a plurality of directed graphs comprising nodes and edges. Each node represents a test in the plurality of tests and each edge from a first node to a second node represents creation of an output, by the first node, that is used as an input by the second node. The method continues with storing, in a training database, parametric training data obtained from performance of the test suite on devices other than the given device. The method proceeds with using a machine learning algorithm, trained using the stored parametric training data, to perform two processes. The first process predicts, for each test in the plurality of tests, whether performance of that test on the given device is likelier to succeed or fail according to parametric data for the given device. The second process generates a confidence value for each such prediction. The method concludes with creating, for performance on the given device, a test suite comprising the plurality of tests rearranged according to a modified order. At least one test, predicted to fail by the prediction processor, appears earlier in the modified order than in the initial order.

In some embodiments, the training data comprise a plurality of records, each record relating to a test and including data indicating both success or failure of the test, and one or more of: a unique device identifier, a device operating system identifier, a device testing application version, a device model identifier, a test identifier, a test cycle number, a dependency tree identifier, and a dependency tree level identifier.

In some embodiments, predicting performance of at least one test in the plurality of tests comprises aggregating predictions of a plurality of decision trees in a random forest, and wherein generating the confidence value comprises computing a ratio of (a) the number of decision trees within the plurality of decision trees whose predictions agree with the predicted performance, to (b) the number of trees in the plurality of trees.

In some embodiments, creating the test suite according to the modified order comprises (a) determining a set of directed paths, in the plurality of directed graphs, that each end on a node that represents a test that was predicted likelier to fail than successful; then (b) ordering the set of directed graphs by increasing length of the shortest directed path therein; and then (c) further ordering the set of directed graphs by decreasing maximum confidence value.

In some embodiments, the set of directed paths includes, for each test that was predicted likelier to fail than successful, identifying the edges in a corresponding directed path for that test by traversing the directed graph that comprises the test from the node representing that test to a root node.

Some embodiments further include performing, on the given device by each of a plurality of testing processors, the tests represented by nodes in a corresponding directed path according to the modified order.

And some embodiments also include (a) storing, in the training database, parametric training data obtained from performing the tests according to the modified order; and (b) retraining the machine learning algorithm using the updated, stored parametric training data.

Yet another embodiment is a tangible, computer-readable storage medium, in which is non-transitorily stored computer program code that, when executed by a computing processor, performs any of the methods described above.

It is appreciated that the concepts, techniques, and structures disclosed herein may be embodied in other ways, and thus that the above summary of embodiments should be viewed as only illustrative, and not comprehensive or limiting.

### DESCRIPTION OF THE SEVERAL VIEWS OF THE DRAWINGS

The manner and process of making and using the disclosed embodiments may be appreciated by reference to the drawings, in which:

FIG. 1 schematically shows a hypothetical sequence of test cases for testing a feature;

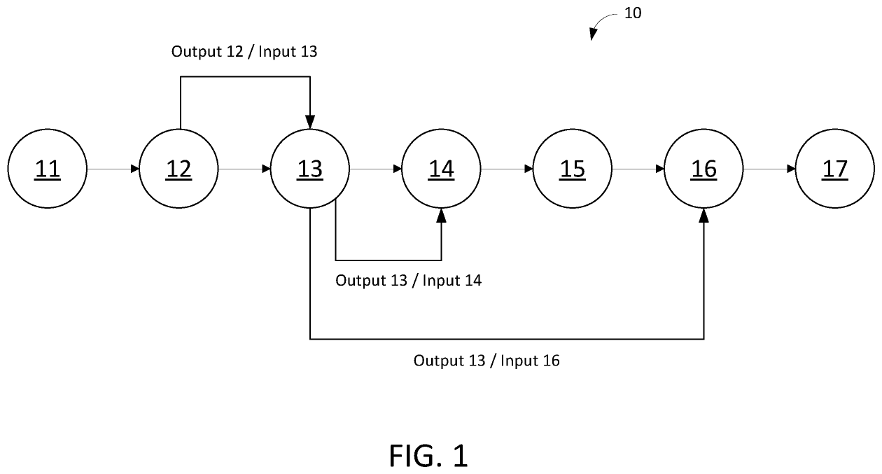

FIG. 2 schematically shows a test suite having multiple sequences of test cases;

FIG. 3 schematically shows the test suite of FIG. 2 after structural decomposition in accordance with an embodiment of the concepts, techniques, and structures disclosed herein;

FIG. 4 schematically shows the test suite of FIG. 3 highlighting nodes that represent tests determined likely to fail according to an embodiment;

FIG. 5 schematically shows an initial portion of the test suite of FIG. 4 after reordering according to an embodiment so that tests determined likely to fail appear earlier in the testing sequence;

FIG. 6 schematically shows a system for reordering execution of a test suite according to an embodiment;

FIG. 7 is a flowchart for a method of reordering execution of a test suite according to an embodiment; and

FIG. 8 schematically shows relevant physical components of a computer that may be used to embody, in whole or in part, the concepts, structures, and techniques disclosed herein.

### DETAILED DESCRIPTION OF EMBODIMENTS

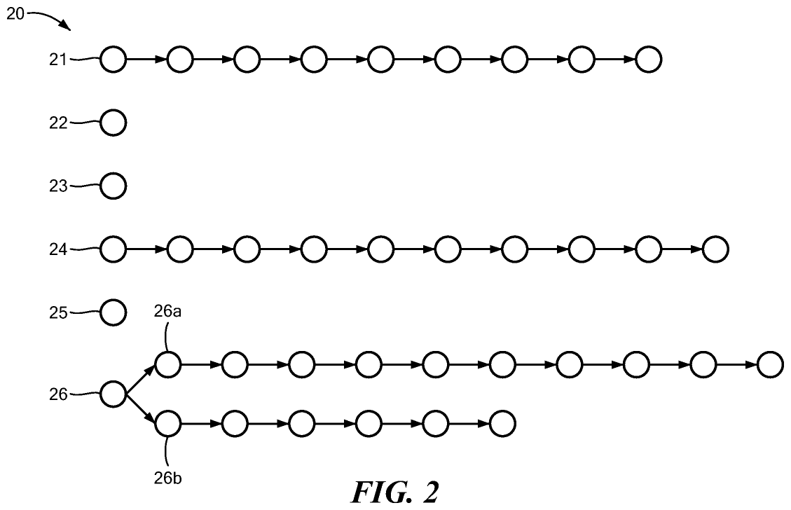

In FIG. 2 is schematically shown a graphical representation of an illustrative test suite 20 for a device under test. The device may be any machine or manufacture known in the art, and may have several features of its hardware, or its software in the case of a computerized device, that must be tested before the device may be cleared for release to an end user. Therefore, the test suite 20 has multiple sequences 21-26 of test cases (or simply “tests”) that may be performed, each sequence used to determine whether a corresponding feature has been properly built or otherwise correctly implemented. The use of such test sequences 21-26 for this purpose is known in the art when performed in a static, pre-defined order.

To be concrete, the test suite 20 of FIG. 2 includes six test sequences, one for each of six different features to be tested. The first sequence 21 includes nine tests, each represented by a circle or “node”, and these tests are executed in order of the nodes in the sequence (e.g. from left to right). The substance of the tests may be determined by a design engineer familiar with the feature to be tested, and their order may be determined so that the results of early tests may be provided to later tests. Thus, one or more tests in the first sequence 21 may be dependent on other tests in the sequence.

The second sequence 22 includes only a single test. Likewise, the third sequence 23 includes only a single test. Such single-test sequences may be referred to herein as “atomic”. The fourth sequence 24 includes ten tests to be executed in order, while the fifth sequence 25 has only a single test. The sixth sequence 26 is bifurcated, and includes a first test that determines which of the two subsequences 26a or 26b to execute (e.g. based on the presence or absence of another feature). Thus, there are three atomic test cases 22, 23, 25, and three dependent test case groups 21, 24, 26. The test cases in each dependent test case group 21, 24, 26 are dependent on each other, but the nature of their dependency is unclear from this linear presentation. However, the tests in each test sequence are not dependent on any test in another sequence.

It is appreciated that FIG. 2 is merely illustrative of a test suite to which embodiments may be applied, and that other test suites may be encountered in practice. Thus, any given device may have greater or fewer than six features to be tested, and testing each feature may require any positive number of tests.

As known in the art, different design engineers may provide the different features of the device to be tested, and therefore may independently design the test sequences 21-26. Because the logic behind the order of such test sequences may not be known to other engineers, these sequences are treated by those assembling test suites (such as test suite 20) as “black box” or “opaque” building blocks. Thus, “monolithic” test suites in the prior art are formed simply by concatenating these sequences together. Once formed, these test sequences are applied in order and without modification to each device, leading to potential inefficiencies in detecting failed components or features.

By contrast, embodiments of the concepts, techniques, and structures disclosed herein provide a systematic, structural decomposition to the monolithic test case suite to build trees (directed graphs) based on the dependencies between the tests in each sequence. After building each tree, an ensemble bagging-based machine learning (“ML”) model is applied to predict the context of test failures, and individual test cases that are likely to fail. Based on the failure context, reprioritization of the sequences of dependent test case groups and atomic test cases is performed in such a manner that the test cases that are likely to fail will run first in the next test cycle. Moreover, applying parallel execution of the test sequences can dramatically improve the run time for each device.

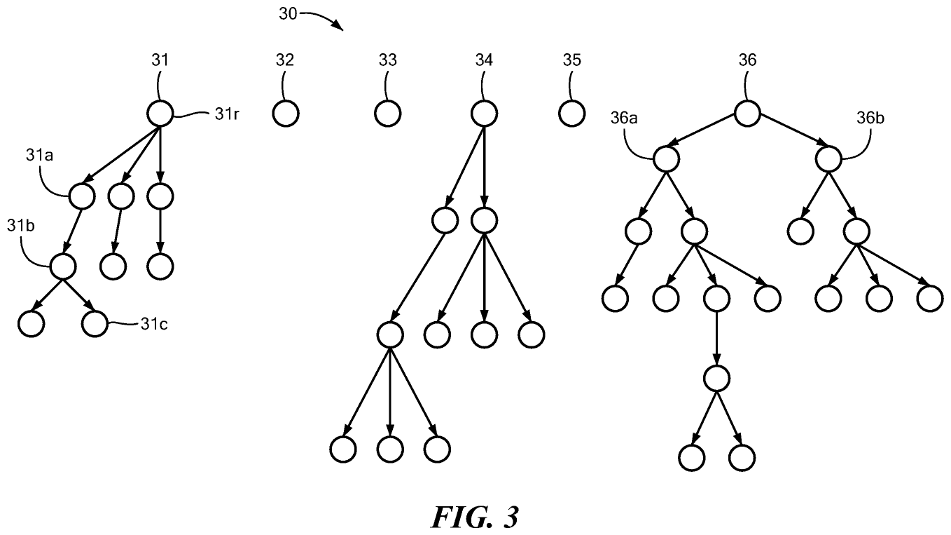

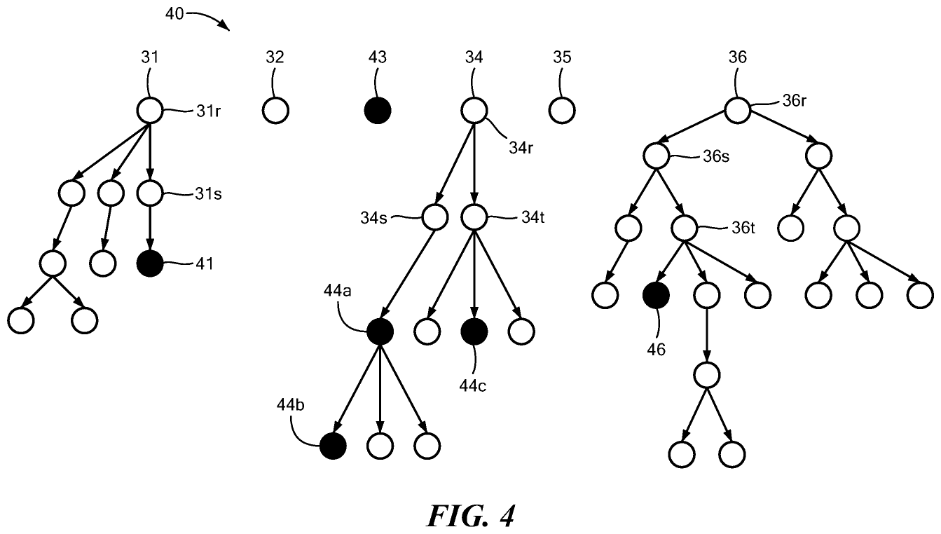

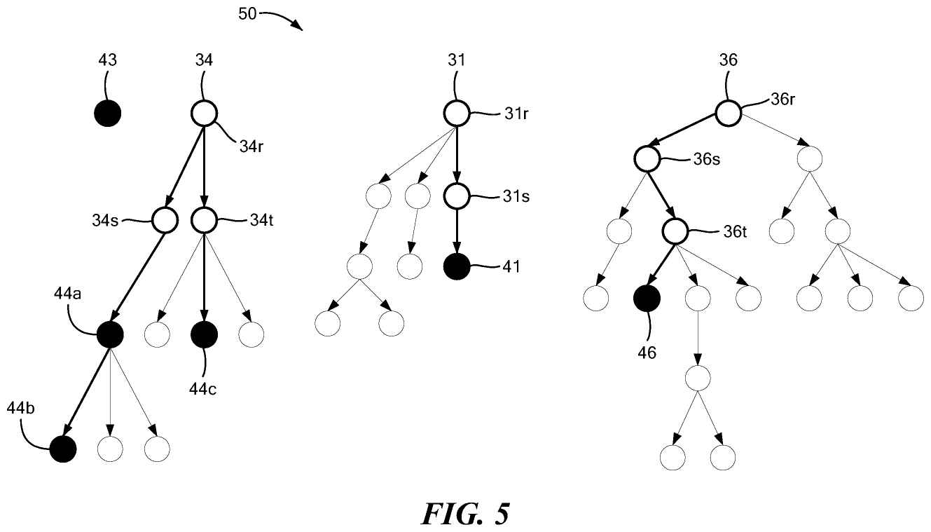

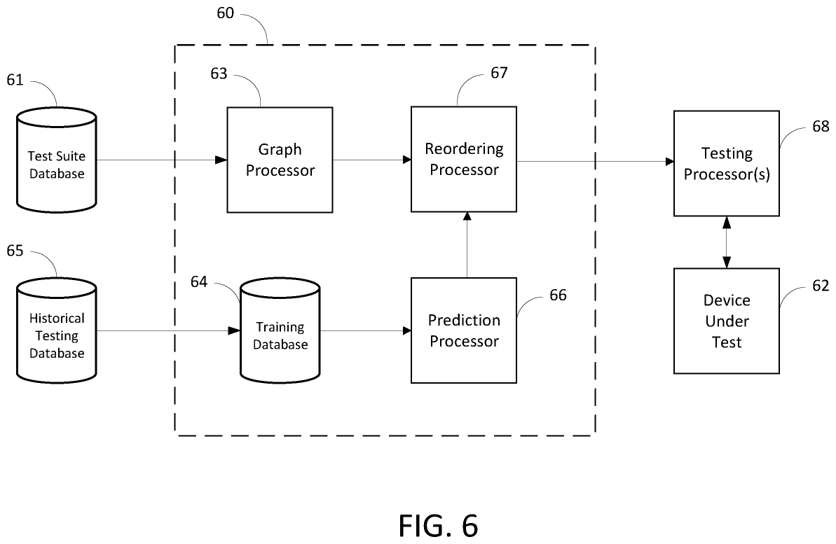

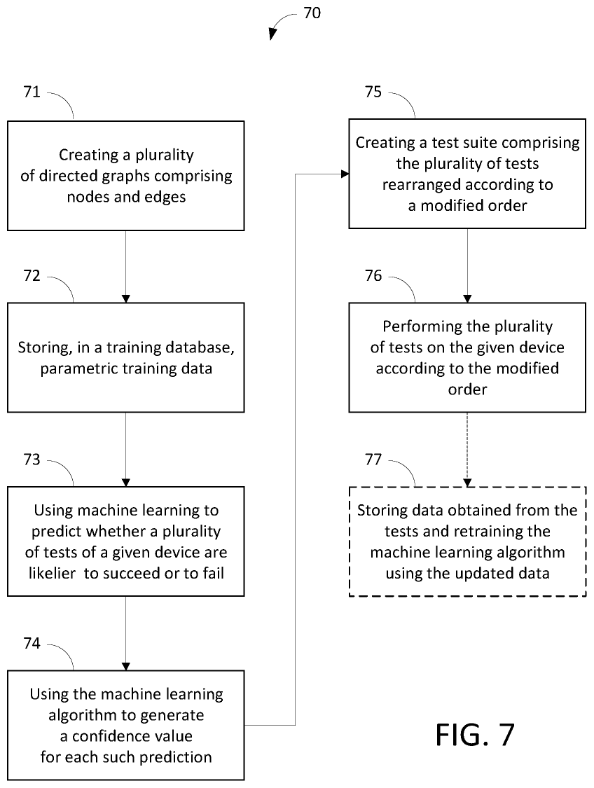

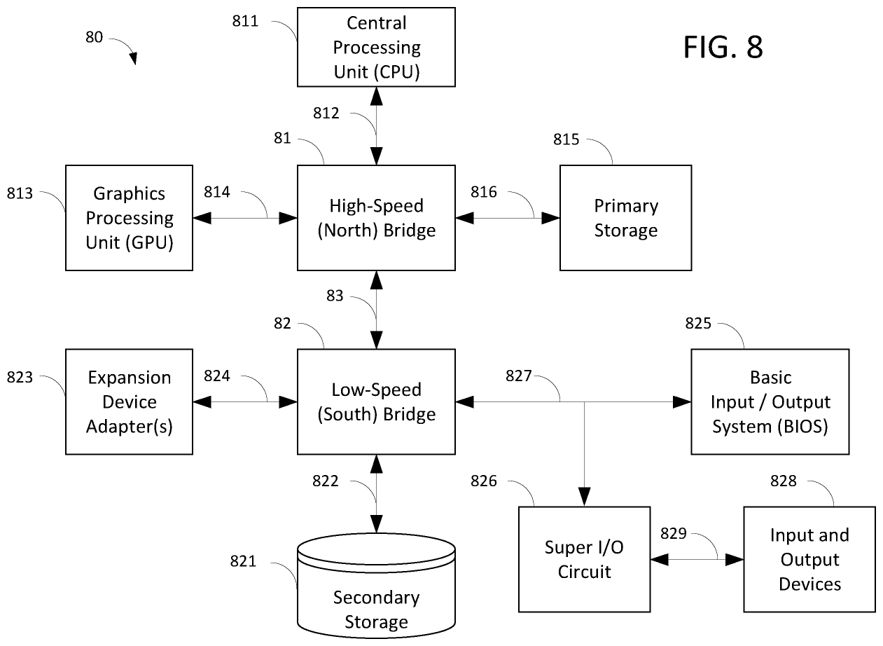

Embodiments are now described in detail with reference to these three different stages of processing. Stage 1 relates to structural decomposition of the test sequences, and is illustrated in FIG. 3, using the hypothetical test suite of FIG. 2 as a concrete example with which to explain the concepts, techniques, and structures involved. Stage 2 relates to applying machine learning to historical test data, and its effects on the exemplary test suite are illustrated in FIG. 4. Stage 3 relates to reordering of the test sequences to prioritize tests likely to fail, and its effects on the exemplary test suite are illustrated in FIG. 5. A system for performing these processes is shown in FIG. 6, and a method of performing these processes is shown in FIG. 7. Finally, a computer that may be used to implement all or any portion of the system or method is shown in FIG. 8.

With reference now to FIG. 3, schematically shown is the test suite of FIG. 2 after Stage 1 structural decomposition in accordance with an embodiment of the concepts, techniques, and structures disclosed herein. The modified test suite 30 includes the linear test sequences of the original test suite 20 after processing into directed graphs or trees 31-36 that reflect actual input/output dependencies between the tests.

Thus, directed graph 31 contains nine test nodes corresponding to the nine tests of linear test sequence 21. In this illustration, the directed graph 31 includes a root node 31r from which all other tests follow in testing order. Each node in each directed graph is separated from its root node by a number of edges herein called its “level”. Illustratively with respect to directed graph 31, the root node 31r has level 0, test node 31a has level 1, test node 31b has level 2, and test node 31c has level 3. In general, each test at a given level is performed prior to each test for which it is a “parent” in the directed graph, i.e. each test to which an edge extends from the given test at the next higher level.

Due to the sequencing indicated, the test of node 31a may use as input, the output of the test of root node 31r. Likewise, the test of node 31b may use as input, the output of the test of node 31a, and the test of node 31c may use as input the output of the test of node 31b. Thus, the test of node 31c has available for use as potential inputs, the outputs of all of its “ancestor” nodes 31r, 31a, and 31b. While it may be assumed that the linear order of test sequence 21 enables the successful completion of all nine tests, the directed graph 31 makes the exact dependencies clear, and allows for finer-grained prioritization of individual, dependent tests as described below in more detail.

It is appreciated that, while any given test may have many outputs available for use as its inputs, the given test need not use all of those inputs; rather, the sequencing indicated in FIG. 3 merely enables such use. For example, it may be that the tests of nodes 31a and 31b may execute independently of each other, but the test of node 31c requires both of their outputs as its own input. Therefore, the tests of nodes 31a and 31b both must execute before the test of node 31c, and therefore both must appear in a single, directed path above node 31c, as shown.

The structural decomposition of the remaining sequences proceeds in the same manner, and is now described for completeness. The directed graph 32 contains only one node, corresponding to the atomic test 22. Likewise, the directed graph 33 contains only one node, corresponding to the atomic test 23. The ten tests of linear test sequence 24 are arranged according to their input/output dependencies as directed graph 34, which also contains ten nodes. The directed graph 35 contains one node corresponding to the atomic test 25. Finally, the directed graph 36 corresponds to the bifurcated sequence 26. The directed graph 36 contains two subgraphs 36a and 36b, which correspond to the subsequences 26a and 26b, respectively.

In FIG. 4 is schematically shown the test suite of FIG. 3, after applying machine learning to historical test data in Stage 2 to determine highlighted nodes that represent tests likely to fail. One such node is in directed graph 31, with directed path from the root node 31r, through the level 1 node 31s, to the level 2 node 41 that is expected to fail. This directed path may be described briefly as (31r, 31s, 41). Another such node is in directed graph 33, and is the root node 43 with directed path (43). Other nodes expected to fail are nodes 44a, 44b, and 44c in directed graph 34. The first two such nodes are contained in a single directed path (34r, 34s, 44a, 44b), and the third in a directed path (34r, 34t, 44c). Finally, there is a directed path (36r, 36s, 36t, 46) in the directed graph 36. These nodes that are likely to fail are merely illustrative, and practical embodiments may experience greater or fewer such nodes, in greater or fewer different directed graphs.

The nodes 41, 43, 44a, 44b, 44c, and 46 that represent tests more likely than not to fail are determined predicted in Stage 2 using machine learning, as now described. First, a set of training parameters is determined. Next, training data are gathered according to those parameters in a training database. Then, a machine learning algorithm is trained on those training data. Finally, the algorithm is used to predict, for a given device, whether each test is more likely to succeed or fail, and a confidence value for this prediction.

Any set of training parameters that pertain to the type of device under test may be used. Illustrative devices under test are described herein as laptop computers for the sake of concreteness, but it is appreciated that other devices may be tested according to the concepts, techniques, and structures disclosed herein, when suitably adapted. One training parameter must be the target classification, which in accordance with embodiments is whether an individual test iteration passed or failed. Additional parameters include the following.

In illustrative embodiments, one device parameter may be a unique device identifier, such as a universally unique identifier (UUID) or other serial number. Another parameter may be an operating system identifier, such as “Windows 10”. Another parameter may be a device testing application version identifier, if a particular application is being tested. Another parameter may be a device model identifier, such as “XPS 13”. Another parameter may be a test identifier, which may be a combination of a directed graph (tree) identifier and a test case number, or any similar data. Another parameter may be a test cycle number that indicates the iteration of the particular test on the device, in case repeated tests produce different results. Another parameter may be the level within a tree at which the particular test may be found (e.g. level 0 for the root node, level 1 for a node adjacent to the root node, and so on), which may be determined using a breadth-first search for a particular test within directed graphs produced by Stage 1 processing.

Once these training parameters have been identified, historical data collected from past testing according to these parameters (e.g. via device telemetry or instrumentation) are assembled into a training database. These data form a multi-dimensional parameter space, with each point in the space corresponding to a particular test and classified as a success or failure. Presumably, tests having similar parameters will yield similar results, so test successes and failures will cluster together in this multi-dimensional space, allowing machine learning techniques to provide reliable classification of new points.

Thus, a machine learning algorithm is trained using the training data to produce a model that permits prediction of a classification (e.g. success or failure) of subsequent tests on the basis of arbitrary input parameters, i.e. arbitrary new points in the parameter space. To make these predictions, various embodiments use random forest classification, as known in the art. It is appreciated that other machine learning models may be used; however, the random forest model is advantageous for a number of reasons described below. Random forest uses “bagging” (bootstrap aggregating) to generate predictions. This process includes using multiple classifiers, each trained on different data samples and different features, which may be executed in parallel. The final classification is achieved by aggregating the predictions that were made by the different classifiers, e.g. by averaging.

A random forest is composed of multiple classifiers in the form of decision trees, and each decision tree is constructed using different parameters and different data samples which reduces the bias and variance of the aggregate. Each decision tree may include a sequence of decisions to be made, each decision depending on the last, and the branches of decision making form the decision tree. The individual decisions themselves may take the form of, e.g., “is the value of parameter X between values Y and Z?” In the training process, many decision trees are constructed using the training data. Then in the testing or prediction process, each new data point is run through the different decision trees, each decision tree yields a tentative classification or “vote”, and the final prediction in determined by majority voting (i.e. determining which class, success or failure, got a majority of votes).

The underling concept of the random forest is based on is the wisdom of crowds: instead of using just one model (decision tree) to make a prediction, random forest uses multiple and uncorrelated decision trees to outperform the accuracy of a single decision tree. The use of multiple decision trees minimizes the effect of an error occurring in an individual tree. While some trees might be wrong, most trees will be right, so overall as a group the prediction will go in the right direction.

The random forest algorithm has several advantages in connection with the problem to be solved, namely reordering test execution to prioritize tests likely to fail. A major advantage is the accuracy of the predictive power of the algorithm. Next, random forest can be used for both classification and regression tasks, as individual decisions can be structured to fit many types of parameter data (including binary, categorical, and numerical). In addition, little pre-processing is needed on the training data, and the use of the model does not require rescaling or transforming the data. Furthermore, random forest works well on subsets of high-dimensional data. Another important advantage that is very relevant to solving this problem is high training speed, and fast prediction generation. And finally, this model is very robust to outliers and non-linear data, and performs well with unbalanced data.

Most machine learning models only provide a classification result. However, illustrative embodiments go farther to provide probability estimates that the result is actually correct. Because the final classification result (e.g. success or failure) is the result of a majority vote of a potentially large number of decision trees, it is possible to leverage the individual votes to determine a confidence in that final result. Thus, if all decision trees agree that a given test is likely to succeed, then the final classification may have a high confidence, while if the vote is close, then the final classification may be less confident. A confidence value may be generated as a ratio of the number of decision trees whose predictions agree with the predicted performance, to the total number of decision trees. Thus, each confidence value will be at least 50%. For example, if 20 decision trees are used in the model, and 15 trees predict success and 5 trees predict failure on particular input parameters, then (a) the predicted class is “success”, but moreover (b) the confidence value in this prediction is 15/20=75%. The use of these confidence values to reorder test execution is a further advantage over the prior art, as described below.

FIG. 5 schematically shows an initial portion 50 of the test suite of FIG. 4 after Stage 3 reordering according to an embodiment, so that tests determined likely to fail appear earlier in the testing sequence. Recall that these tests had nodes 41 (in directed graph 31), 43 (in directed graph 33), 44a, 44b, and 44c (in directed graph 34), and 46 (in directed graph 36). Therefore, the initial portion 50 shown in FIG. 5 includes the directed graphs 31, 33, 34, and 36. The directed graphs 32 and 35 had no predicted failures, and thus comprise a terminal portion of the test suite after Stage 3 reordering.

To ensure that tests most likely to fail occur as soon as possible in the test suite 50, the directed graphs that contain probable failure nodes are reorganized as follows. First, a set of directed paths that each end on a probable failure node is determined. These directed paths were described above, e.g. the directed path (34r, 34t, 44c) that ends on probable failure node 44c. These paths may be determined by first locating each failure node within the directed graph (e.g. by breadth first search), then traversing the tree from the failure node to the root node, where the directed path is executed in the reverse order of the traversal. The directed paths from the root nodes to the failure nodes may be stored in a database with a composite unique key (e.g. Device ID+Test Case ID+Tree ID) for later quick retrieval during actual testing.

Next, the directed graphs are ordered by increasing length of the shortest directed path therein. In this way, the directed graphs containing the shortest directed paths appear earliest in the reordering. Following this process, node 43 appears first in the reorder as its directed path (43) has length zero. Next, the directed graphs 34 and 31 appear, as the shortest directed path in each has length two—i.e. (34r, 34t, 44c) in directed graph 34 and (31r, 31s, 41) in directed graph 31. Finally there appears directed graph 36, whose shortest such directed path (36r, 36s, 36t, 46) has length 3.

To the extent that any further reordering is required, directed paths having the same number of edges are ordered by decreasing maximum confidence value, i.e. with those having a node with the highest confidence of failure are reordered for execution first. In this way, the first directed graphs executed are those having tests determined to be the most likely to fail, out of all tests determined probable to fail. Thus, as between directed graphs 31 and 34, the directed graph 34 is shown earlier in the reordered test suite 50 on the basis that one of its failure nodes 44a, 44b, or 44c has a higher confidence value of failure than does the failure node 41 in directed graph 31.

Reordering the directed graphs in this manner permits parallelization of testing. Thus, many testing processors may be used, with each testing processor configured to perform, on the given device simultaneously, the tests represented by nodes in a directed path according to the modified order. To speed up failure detection even farther, each testing processor may first execute its failure directed paths, then its non-failure directed paths.

Having now described the operation of various embodiments, in FIG. 6 is schematically shown a system 60 for reordering execution of a test suite according to an embodiment. The test suite is stored in a test suite database 61, and comprises a plurality of tests to be performed on a given device 62 under test according to an initial order. The tests to be performed may be provided according to the initial order as discussed above in connection with the test suite shown in FIG. 2.

The system 60 includes a graph processor 63 for creating a plurality of directed graphs comprising nodes and edges. Each node in a directed graph represents a test in the plurality of tests. Moreover, each edge from a first node to a second node represents creation of an output, by the first node, that is used as an input by the second node. Thus, the graph processor 63 may be used to implement Stage 1 processing as described above, converting the test suite shown in FIG. 2 to that shown in FIG. 3.

The system 60 includes a training database 64 for storing parametric training data obtained from performance of the test suite on devices other than the given device 62. The parametric training data may be obtained from a historical testing database 65. The parametric training data may include, for example, a plurality of records, each record relating to a test. Each record includes both data indicating both success or failure of the test, and one or more parameters, on the basis of which a classification into success or failure may be determined using machine learning, as discussed above in connection with FIG. 4. These parameters illustratively include: a unique device identifier, a device operating system identifier, a device testing application version, a device model identifier, a test identifier, a test cycle number, a dependency tree identifier, and a dependency tree level identifier. The training database 64 may be implemented using any database technology known in the art.

The system 60 includes a prediction processor 66 for using a machine learning algorithm, trained using data stored in the training database 64. The prediction processor 66 is configured to predict, for each test in the plurality of tests, whether performance of that test on the given device 62 is likelier to succeed or fail according to parametric data for the given device 62. The prediction processor 66 also generates a confidence value for each such prediction, as discussed in connection with the Stage 2 processes of FIG. 4.

The prediction processor 66 may use a random forest machine learning algorithm to predict performance of at least one test in the plurality of tests by aggregating predictions of a plurality of decision trees in a random forest. The prediction processor 66 may also generate the confidence value as a ratio of (a) the number of decision trees within the plurality of decision trees whose predictions agree with the predicted performance, to (b) the number of trees in the plurality of trees. Thus, the output of the prediction processor 66 may be viewed as data that indicate which tests in the test suite are likely to fail.

The system 60 includes a reordering processor 67 for creating, for performance on the given device 62, a test suite comprising the plurality of tests rearranged according to a modified order. The reordering processor 67 combines the tests predicted to fail by the prediction processor 66 with the directed graphs produced by the graph processor 63 to perform Stage 3 operations, and specifically reordering as discussed above in connection with FIG. 5.

In accordance with embodiments, at least one test, predicted to fail by the prediction processor 66, appears earlier in the modified order than it does in the initial order obtained from the test suite database 61. Thus, embodiments accelerate the detection of tests predicted to fail, providing a speed advantage over the prior art.

The reordering processor 67 may create the test suite according to the modified order by determining a set of directed paths, in the plurality of directed graphs produced by the graph processor 63, that each end on a node that represents a test that was predicted likelier to fail than successful. The reordering processor 67 may then order the set of directed graphs by increasing length of the shortest directed path therein, and further order the set of directed graphs by decreasing maximum confidence value. As discussed above, determining the set of directed paths may be performed, for each test that was predicted likelier to fail than successful, by identifying the edges in a corresponding directed path for that test by traversing the directed graph that comprises the test from the node representing that test to a root node.

In some embodiments, the system 60 also includes one or more testing processors 68. Each testing processor 68 is configured to perform, on the given device 62, the tests represented by nodes in a directed path according to the modified order. The testing processors 67 are shown separately in FIG. 6 because they may be separately provided.

In various embodiments, the graph processor 63, or the prediction processor 66, or the reordering processor 67, or the testing processors 68, or any combination thereof, may be implemented using a central processing unit (CPU), or an application-specific integrated circuit (ASIC), or a field-programmable gate array (FPGA), or as any combination of these, and may use volatile or non-volatile memory to store intermediate or final computational data. Also, these processors may be implemented as a single processor or multiple processors executing within a single computer system according to software that provides their respective functions.

FIG. 7 is a flowchart for a method 70 of reordering execution of a test suite according to an embodiment. The test suite is stored in a test suite database and comprises a plurality of tests to be performed on a given device according to an initial order. The method 70 may be implemented by the system 60 shown in FIG. 6, or by a different machine or combination of machines.

The method 70 begins with a process 71 creating a plurality of directed graphs comprising nodes and edges. Each node represents a test in the plurality of tests and each edge from a first node to a second node represents creation of an output, by the first node, that is used as an input by the second node. The process 71 may be performed by the graph processor 63, by other suitable means.

The method 70 continues with a process 72 storing, in a training database, parametric training data obtained from performance of the test suite on devices other than the given device; that is, historical testing data. The training database may be the training database 64 or other means suitable for storing data. The training data may include a plurality of records, each record relating to a test and including data indicating both success or failure of the test, and one or more of: a unique device identifier, a device operating system identifier, a device testing application version, a device model identifier, a test identifier, a test cycle number, a dependency tree identifier, and a dependency tree level identifier.

The method 70 next moves to a process 73 using a machine learning algorithm, trained using the stored parametric training data, to predict, for each test in the plurality of tests, whether performance of that test on the given device is likelier to succeed or fail according to parametric data for the given device. In various embodiments, predicting performance of at least one test in the plurality of tests comprises aggregating predictions of a plurality of decision trees in a random forest.

The method 70 then performs a process 74 using the machine learning algorithm to generate a confidence value for each such prediction. Generating the confidence value may include computing a ratio of (a) the number of decision trees within the plurality of decision trees whose predictions agree with the predicted performance, to (b) the number of trees in the plurality of trees. The processes 73 and 74 may be performed by the prediction processor 66, or by other suitable means.

The method 70 advances to a process 75 creating, for performance on the given device, a test suite comprising the plurality of tests rearranged according to a modified order. The process 75 may include determining a set of directed paths, in the plurality of directed graphs, that each end on a node that represents a test that was predicted likelier to fail than successful. The process 75 also may include ordering the set of directed graphs by increasing length of the shortest directed path therein, and further ordering the set of directed graphs by decreasing maximum confidence value. Determining the set of directed paths may include, for each test that was predicted likelier to fail than successful, identifying the edges in a corresponding directed path for that test by traversing the directed graph that comprises the test from the node representing that test to a root node. The process 75 may be implemented by the reordering processor 67, or by other suitable means.

The method 70 further includes a process 76 performing, on the given device by each of a plurality of testing processors, the tests represented by nodes in a corresponding directed path according to the modified order. The process 76 may be implemented by the testing processors 68, or by other suitable testing apparatus.

In some embodiments, the method 70 may also include a process 77 storing, in the training database, parametric training data obtained from performing the tests according to the modified order; and retraining the machine learning algorithm using the updated, stored parametric training data. Thus, the training database may be continually updated with new data so that further applications of the method 70 will increase in accuracy and speed.

FIG. 8 schematically shows relevant physical components of a computer 80 that may be used to embody the concepts, structures, and techniques disclosed herein. In particular, the computer 80 may be used to implement, in whole or in part: the Stage 1 structural decomposition illustrated by FIG. 3; or the Stage 2 machine learning illustrated by FIG. 4; or the Stage 3 reordering illustrated by FIG. 5; or the system 60 for reordering execution of a test suite shown in FIG. 6; or the method 70 for reordering execution of a test suite shown in FIG. 7; or any combination thereof. Generally, the computer 80 has many functional components that communicate data with each other using data buses. The functional components of FIG. 8 are physically arranged based on the speed at which each must operate, and the technology used to communicate data using buses at the necessary speeds to permit such operation.

Thus, the computer 80 is arranged as high-speed components and buses 811 to 816 and low-speed components and buses 821 to 829. The high-speed components and buses 811 to 816 are coupled for data communication using a high-speed bridge 81, also called a “northbridge,” while the low-speed components and buses 821 to 829 are coupled using a low-speed bridge 82, also called a “southbridge.”

The computer 80 includes a central processing unit (“CPU”) 811 coupled to the high-speed bridge 81 via a bus 812. The CPU 811 is electronic circuitry that carries out the instructions of a computer program. As is known in the art, the CPU 811 may be implemented as a microprocessor; that is, as an integrated circuit (“IC”; also called a “chip” or “microchip”). In some embodiments, the CPU 811 may be implemented as a microcontroller for embedded applications, or according to other embodiments known in the art.

The bus 812 may be implemented using any technology known in the art for interconnection of CPUs (or more particularly, of microprocessors). For example, the bus 812 may be implemented using the HyperTransport architecture developed initially by AMD, the Intel QuickPath Interconnect (“QPI”), or a similar technology. In some embodiments, the functions of the high-speed bridge 81 may be implemented in whole or in part by the CPU 811, obviating the need for the bus 812.

The computer 80 includes one or more graphics processing units (GPUs) 813 coupled to the high-speed bridge 81 via a graphics bus 814. Each GPU 813 is designed to process commands from the CPU 811 into image data for display on a display screen (not shown). In some embodiments, the CPU 811 performs graphics processing directly, obviating the need for a separate GPU 813 and graphics bus 814. In other embodiments, a GPU 813 is physically embodied as an integrated circuit separate from the CPU 811 and may be physically detachable from the computer 80 if embodied on an expansion card, such as a video card. The GPU 813 may store image data (or other data, if the GPU 813 is used as an auxiliary computing processor) in a graphics buffer.

The graphics bus 814 may be implemented using any technology known in the art for data communication between a CPU and a GPU. For example, the graphics bus 814 may be implemented using the Peripheral Component Interconnect Express (“PCI Express” or “PCIe”) standard, or a similar technology.

The computer 80 includes a primary storage 815 coupled to the high-speed bridge 81 via a memory bus 816. The primary storage 815, which may be called “main memory” or simply “memory” herein, includes computer program instructions, data, or both, for use by the CPU 811. The primary storage 815 may include random-access memory (“RAM”). RAM is “volatile” if its data are lost when power is removed, and “non-volatile” if its data are retained without applied power. Typically, volatile RAM is used when the computer 80 is “awake” and executing a program, and when the computer 80 is temporarily “asleep”, while non-volatile RAM (“NVRAM”) is used when the computer 80 is “hibernating”; however, embodiments may vary. Volatile RAM may be, for example, dynamic (“DRAM”), synchronous (“SDRAM”), and double-data rate (“DDR SDRAM”). Non-volatile RAM may be, for example, solid-state flash memory. RAM may be physically provided as one or more dual in-line memory modules (“DIMMs”), or other, similar technology known in the art.

The memory bus 816 may be implemented using any technology known in the art for data communication between a CPU and a primary storage. The memory bus 816 may comprise an address bus for electrically indicating a storage address, and a data bus for transmitting program instructions and data to, and receiving them from, the primary storage 815. For example, if data are stored and retrieved 64 bits (eight bytes) at a time, then the data bus has a width of 64 bits. Continuing this example, if the address bus has a width of 32 bits, then 2³² memory addresses are accessible, so the computer 80 may use up to 8*2³²=32 gigabytes (GB) of primary storage 815. In this example, the memory bus 816 will have a total width of 64+32=96 bits. The computer 80 also may include a memory controller circuit (not shown) that converts electrical signals received from the memory bus 816 to electrical signals expected by physical pins in the primary storage 815, and vice versa.

Computer memory may be hierarchically organized based on a tradeoff between memory response time and memory size, so depictions and references herein to types of memory as being in certain physical locations are for illustration only. Thus, some embodiments (e.g. embedded systems) provide the CPU 811, the graphics processing units 813, the primary storage 815, and the high-speed bridge 81, or any combination thereof, as a single integrated circuit. In such embodiments, buses 812, 814, 816 may form part of the same integrated circuit and need not be physically separate. Other designs for the computer 80 may embody the functions of the CPU 811, graphics processing units 813, and the primary storage 815 in different configurations, obviating the need for one or more of the buses 812, 814, 816.

The depiction of the high-speed bridge 81 coupled to the CPU 811, GPU 813, and primary storage 815 is merely exemplary, as other components may be coupled for communication with the high-speed bridge 81. For example, a network interface controller (“NIC” or “network adapter”) may be coupled to the high-speed bridge 81, for transmitting and receiving data using a data channel. The NIC may store data to be transmitted to, and received from, the data channel in a network data buffer.

The high-speed bridge 81 is coupled for data communication with the low-speed bridge 82 using an internal data bus 83. Control circuitry (not shown) may be required for transmitting and receiving data at different speeds. The internal data bus 83 may be implemented using the Intel Direct Media Interface (“DMI”) or a similar technology.

The computer 80 includes a secondary storage 821 coupled to the low-speed bridge 82 via a storage bus 822. The secondary storage 821, which may be called “auxiliary memory”, “auxiliary storage”, or “external memory” herein, stores program instructions and data for access at relatively low speeds and over relatively long durations. Since such durations may include removal of power from the computer 80, the secondary storage 821 may include non-volatile memory (which may or may not be randomly accessible).

Non-volatile memory may comprise solid-state memory having no moving parts, for example a flash drive or solid-state drive. Alternately, non-volatile memory may comprise a moving disc or tape for storing data and an apparatus for reading (and possibly writing) the data. Data may be stored (and possibly rewritten) optically, for example on a compact disc (“CD”), digital video disc (“DVD”), or Blu-ray disc (“BD”), or magnetically, for example on a disc in a hard disk drive (“HDD”) or a floppy disk, or on a digital audio tape (“DAT”). Non-volatile memory may be, for example, read-only (“ROM”), write-once read-many (“WORM”), programmable (“PROM”), erasable (“EPROM”), or electrically erasable (“EEPROM”).

The storage bus 822 may be implemented using any technology known in the art for data communication between a CPU and a secondary storage and may include a host adaptor (not shown) for adapting electrical signals from the low-speed bridge 82 to a format expected by physical pins on the secondary storage 821, and vice versa. For example, the storage bus 822 may use a Universal Serial Bus (“USB”) standard; a Serial AT Attachment (“SATA”) standard; a Parallel AT Attachment (“PATA”) standard such as Integrated Drive Electronics (“IDE”), Enhanced IDE (“EIDE”), ATA Packet Interface (“ATAPI”), or Ultra ATA; a Small Computer System Interface (“SCSI”) standard; or a similar technology.

The computer 80 also includes one or more expansion device adapters 823 coupled to the low-speed bridge 82 via a respective one or more expansion buses 824. Each expansion device adapter 823 permits the computer 80 to communicate with expansion devices (not shown) that provide additional functionality. Such additional functionality may be provided on a separate, removable expansion card, for example an additional graphics card, network card, host adaptor, or specialized processing card.

Each expansion bus 824 may be implemented using any technology known in the art for data communication between a CPU and an expansion device adapter. For example, the expansion bus 824 may transmit and receive electrical signals using a Peripheral Component Interconnect (“PCI”) standard, a data networking standard such as an Ethernet standard, or a similar technology.

The computer 80 includes a basic input/output system (“BIOS”) 825 and a Super I/O circuit 826 coupled to the low-speed bridge 82 via a bus 827. The BIOS 825 is a non-volatile memory used to initialize the hardware of the computer 80 during the power-on process. The Super I/O circuit 826 is an integrated circuit that combines input and output (“I/O”) interfaces for low-speed input and output devices 828, such as a serial mouse and a keyboard. In some embodiments, BIOS functionality is incorporated in the Super I/O circuit 826 directly, obviating the need for a separate BIOS 825.

The bus 827 may be implemented using any technology known in the art for data communication between a CPU, a BIOS (if present), and a Super I/O circuit. For example, the bus 827 may be implemented using a Low Pin Count (“LPC”) bus, an Industry Standard Architecture (“ISA”) bus, or similar technology. The Super I/O circuit 826 is coupled to the I/O devices 828 via one or more buses 829. The buses 829 may be serial buses, parallel buses, other buses known in the art, or a combination of these, depending on the type of I/O devices 828 coupled to the computer 80.

The techniques and structures described herein may be implemented in any of a variety of different forms. For example, features of embodiments may take various forms of communication devices, both wired and wireless; television sets; set top boxes; audio/video devices; laptop, palmtop, desktop, and tablet computers with or without wireless capability; personal digital assistants (PDAs); telephones; pagers; satellite communicators; cameras having communication capability; network interface cards (NICs) and other network interface structures; base stations; access points; integrated circuits; as instructions and/or data structures stored on machine readable media; and/or in other formats. Examples of different types of machine readable media that may be used include floppy diskettes, hard disks, optical disks, compact disc read only memories (CD-ROMs), digital video disks (DVDs), Blu-ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

Having described implementations which serve to illustrate various concepts, structures, and techniques which are the subject of this disclosure, it will now become apparent to those of ordinary skill in the art that other implementations incorporating these concepts, structures, and techniques may be used. Accordingly, it is submitted that that scope of the patent should not be limited to the described implementations but rather should be limited only by the spirit and scope of the following claims.

What is claimed is:

1. A system for reordering execution of a test suite that is stored in a test suite database and that comprises a plurality of tests to be performed on a given device according to an initial order, the system comprising:
a graph processor for creating a plurality of directed graphs comprising nodes and edges, wherein each node represents a test in the plurality of tests and each edge from a first node to a second node represents creation of an output, by the first node, that is used as an input by the second node;
a training database for storing parametric training data obtained from performance of the test suite on devices other than the given device;
a prediction processor for using a machine learning algorithm, trained using data stored in the training database, to:
predict, for each test in the plurality of tests, whether performance of that test on the given device is likelier to succeed or fail according to parametric data for the given device, and
generate a confidence value for each such prediction; and
a reordering processor for creating, for performance on the given device, a test suite comprising the plurality of tests rearranged according to a modified order;
wherein at least one test, predicted to fail by the prediction processor, appears earlier in the modified order than in the initial order.

2. A system according to claim 1, wherein the training data comprise a plurality of records, each record relating to a test and including data indicating both success or failure of the test, and one or more of: a unique device identifier, a device operating system identifier, a device testing application version, a device model identifier, a test identifier, a test cycle number, a dependency tree identifier, and a dependency tree level identifier.

3. A system according to claim 1, wherein the prediction processor is configured to use a random forest machine learning algorithm to:
predict performance of at least one test in the plurality of tests by aggregating predictions of a plurality of decision trees in a random forest; and
generate the confidence value as a ratio of (a) the number of decision trees within the plurality of decision trees whose predictions agree with the predicted performance, to (b) the number of trees in the plurality of trees.

4. A system according to claim 1, wherein the reordering processor creates the test suite according to the modified order by:
determining a set of directed paths, in the plurality of directed graphs, that each end on a node that represents a test that was predicted likelier to fail than successful;
ordering the set of directed graphs by increasing length of the shortest directed path therein; and
further ordering the set of directed graphs by decreasing maximum confidence value.

5. A system according to claim 4, wherein determining the set of directed paths includes, for each test that was predicted likelier to fail than successful, identifying the edges in a corresponding directed path for that test by traversing the directed graph that comprises the test from the node representing that test to a root node.

6. A system according to claim 1, further comprising a plurality of testing processors, each testing processor in the plurality configured to perform, on the given device, the tests represented by nodes in a directed path according to the modified order.

7. A method of reordering execution of a test suite that is stored in a test suite database and that comprises a plurality of tests to be performed on a given device according to an initial order, the method comprising:
creating a plurality of directed graphs comprising nodes and edges, wherein each node represents a test in the plurality of tests and each edge from a first node to a second node represents creation of an output, by the first node, that is used as an input by the second node;
storing, in a training database, parametric training data obtained from performance of the test suite on devices other than the given device;
using a machine learning algorithm, trained using the stored parametric training data, to:
predict, for each test in the plurality of tests, whether performance of that test on the given device is likelier to succeed or fail according to parametric data for the given device, and
generate a confidence value for each such prediction; and
creating, for performance on the given device, a test suite comprising the plurality of tests rearranged according to a modified order;
wherein at least one test, predicted to fail by the prediction processor, appears earlier in the modified order than in the initial order.

8. A method according to claim 7, wherein the training data comprise a plurality of records, each record relating to a test and including data indicating both success or failure of the test, and one or more of: a unique device identifier, a device operating system identifier, a device testing application version, a device model identifier, a test identifier, a test cycle number, a dependency tree identifier, and a dependency tree level identifier.

9. A method according to claim 7, wherein predicting performance of at least one test in the plurality of tests comprises aggregating predictions of a plurality of decision trees in a random forest, and wherein generating the confidence value comprises computing a ratio of (a) the number of decision trees within the plurality of decision trees whose predictions agree with the predicted performance, to (b) the number of trees in the plurality of trees.

10. A method according to claim 7, wherein creating the test suite according to the modified order comprises:
determining a set of directed paths, in the plurality of directed graphs, that each end on a node that represents a test that was predicted likelier to fail than successful;
ordering the set of directed graphs by increasing length of the shortest directed path therein; and
further ordering the set of directed graphs by decreasing maximum confidence value.

11. A method according to claim 10, wherein determining the set of directed paths includes, for each test that was predicted likelier to fail than successful, identifying the edges in a corresponding directed path for that test by traversing the directed graph that comprises the test from the node representing that test to a root node.

12. A method according to claim 7, further comprising performing, on the given device by each of a plurality of testing processors, the tests represented by nodes in a corresponding directed path according to the modified order.

13. A method according to claim 12, further comprising:
storing, in the training database, parametric training data obtained from performing the tests according to the modified order; and
retraining the machine learning algorithm using the updated, stored parametric training data.

14. A tangible, computer-readable storage medium, in which is non-transitorily stored computer program code for performing a method of reordering execution of a test suite that is stored in a test suite database and that comprises a plurality of tests to be performed on a given device according to an initial order, the method comprising:
creating a plurality of directed graphs comprising nodes and edges, wherein each node represents a test in the plurality of tests and each edge from a first node to a second node represents creation of an output, by the first node, that is used as an input by the second node;
storing, in a training database, parametric training data obtained from performance of the test suite on devices other than the given device;
using a machine learning algorithm, trained using the stored parametric training data, to:
predict, for each test in the plurality of tests, whether performance of that test on the given device is likelier to succeed or fail according to parametric data for the given device, and
generate a confidence value for each such prediction; and
creating, for performance on the given device, a test suite comprising the plurality of tests rearranged according to a modified order;
wherein at least one test, predicted to fail by the prediction processor, appears earlier in the modified order than in the initial order.

15. A storage medium according to claim 14, wherein the training data comprise a plurality of records, each record relating to a test and including data indicating both success or failure of the test, and one or more of: a unique device identifier, a device operating system identifier, a device testing application version, a device model identifier, a test identifier, a test cycle number, a dependency tree identifier, and a dependency tree level identifier.

16. A storage medium according to claim 14, wherein predicting performance of at least one test in the plurality of tests comprises aggregating predictions of a plurality of decision trees in a random forest, and wherein generating the confidence value comprises computing a ratio of (a) the number of decision trees within the plurality of decision trees whose predictions agree with the predicted performance, to (b) the number of trees in the plurality of trees.

17. A storage medium according to claim 14, wherein creating the test suite according to the modified order comprises:
determining a set of directed paths, in the plurality of directed graphs, that each end on a node that represents a test that was predicted likelier to fail than successful;
ordering the set of directed graphs by increasing length of the shortest directed path therein; and
further ordering the set of directed graphs by decreasing maximum confidence value.

18. A storage medium according to claim 17, wherein determining the set of directed paths includes, for each test that was predicted likelier to fail than successful, identifying the edges in a corresponding directed path for that test by traversing the directed graph that comprises the test from the node representing that test to a root node.

19. A storage medium according to claim 14, wherein the method further comprises performing, on the given device by one or more testing processors, the tests represented by nodes in a directed path according to the modified order.

20. A storage medium according to claim 19, wherein the method further comprises:
storing, in the training database, parametric training data obtained from performance of the test suite on the given device; and
retraining the machine learning algorithm using the updated, stored parametric training data.
